(19) United States
(12) Patent Application Publication
(10) Pub. No.: US 2007/0291034 A1
(43) Pub. Date: Dec. 20, 2007

(54) System for presenting a navigable virtual subway system, and method for operating and using the same

(76) Inventor: Nelson C. Dones, Croton-Hudson, NY (US)

Correspondence Address: STROOCK & STROOCK & LAVAN LLP, 180 MAIDEN LANE, NEW YORK, NY, 10038, US

(21) Appl. No.: 11/712,748

(22) Filed: Feb. 28, 2007

Related U.S. Application Data
(60) Provisional application No. 60/815,292, filed on Jun. 20, 2006.

(51) Int. Cl. G06T 15/10

(52) U.S. Cl. 345/427

(57) ABSTRACT

A navigable virtual environment that comprises a graphic representation of an environment modeled after a transportation system which is navigable by a user and which provides at least one service to the user appropriate to the transportation system. The environment is preferably rendered in three dimensions and designed to provide the user with a realistic experience in navigating the transportation system. A method of providing a three-dimensional view of a navigable experience to a user is also provided.

This application claims the benefit of U.S. Provisional Application No. 60/815,292, filed Jun. 20, 2006, the contents of which are incorporated herein by reference.

### BACKGROUND OF THE INVENTION

1. Field of the Invention

The present invention relates to a three dimensional, navigable virtual space and, in particular, to a virtual space designed to simulate and provide the experience of the riding of a subway system.

2. Description of the Related Art

The subway systems of major cities, and even some smaller cities, can present a daunting affair for everyday users and new travelers alike. For example, the New York City (NYC) subway system, which is one of the world's largest, has some 26-lines and hundreds of stations in Manhattan alone, not to mention Brooklyn, Queens, and the Bronx. Among the issues for travelers is, not only how to plan their route, but dealing with a lack of familiarity with the departing and arriving stations of a transportation system and the neighborhoods in which the stations are located. Interactive subway maps and even photo and word descriptions of the stations and nearby neighborhoods are no substitute for actual travel on the subway lines.

As such, although such-maps and descriptions will help a rider get from point “A” to point “B”, they will not prepare the rider for what to expect upon arrival at the departing and arriving stations. For instance, using the Metropolitan Transit Authority's (MTA) web site, one can use an interactive subway map of the NYC subway system. The map allows a user to choose a starting an ending point. However, the interactive map provides little or no information about the layout of the departing and arriving stations. In many cases, at least in the NYC subway system, even experienced riders may have difficulty figuring out which side of the platform is the uptown or downtown side. Moreover, at stations that service multiple lines, riders may experience difficulty navigating to the appropriate line or finding the most appropriate exit from the station. For example, the Penn Station stop of the NYC subway system permits the rider to enter and exit at multiple locations—in some cases into Penn Station itself and in other cases directly to the street level. Exiting at the wrong place can leave an unwary traveler blocks away from their desired destination.

Three-dimensional (3D) virtual environments are known in the art. Typically, these 3D environments are created by modeling an environment in software. Software based 3D environments are most prevalent in the gaming industry. For example, the first-person shooter game, DOOM, places the gamer in a 3D virtual environment in which the gamer views the environment from the eyes of the virtual player. The gamer controls and directs the movement of the virtual player within the 3D environment. Such games that include 3D virtual environments almost invariably include fictitious environments designed for the purpose of supporting the game story.

Another example of a use of 3D virtual technology is described U.S. Pat. No. 5,754,189, entitled “Virtual Environment Display Apparatus and Method” (“the '189 patent”). The '189 patent describes a relatively primitive example of the use of 3D technology to enable a human model to be moved through a virtual environment. The '189 patent, however, is designed to permit a user to simulate the operation of a “spot panel” so that the user can be trained in the operation of said spot panel. The '189 patent does not disclose a virtual environment that enables a user to experience the environment itself, interact with that environment, and learn about how to use the environment, while (at least in some cases) providing a forum for the user to communicate with the “real” world.

In U.S. Pat. No. 6,271,843, entitled “Methods Systems And Computer Program Products For Transporting Users In Three Dimensional Virtual Reality Worlds Using Transportation Vehicles” (“the '843 patent”), a system is described in which transportation in a form other than walking is provided between two virtual environment locations in a virtual world. In one example, the transportation vehicle takes the form of a taxi, but can include other “real-life vehicles.” In the '843 patent, the transportation vehicle is designed to permit a user to get from one point to another where using the metaphor of walking for navigation would be unreasonable due to the distance needed to be traveled. However, the inclusion of a transportation vehicle in the '843 patent is not designed to provide the user with the experience of traveling within a real world system, such as the NYC subway system, so that the user can be better prepared to use the real world system. To the contrary, the transportation vehicle in the '843 patent is provided to enhance use of the virtual world, not the real world.

In U.S. Pat. App. Pub. No. US2001/0034661 A1, entitled “Methods and Systems For Presenting A Virtual Representation of a Real City” (“the '661 publication”), a virtual city is described in which users may navigate among a virtual representation of a real region, such as a city. This virtual representation of the city, however, does not present a 3D navigable experience in the sense provided by a true 3D virtual environment. For example, the '661 publication describes that navigation is accomplished by the user selecting a city block on an interactive city map. The interactive city map is a static image of a map that contains hyperlinks to various city blocks within the city. Upon selection, an image of the selected city block is displayed to the user. The image is either a static image or what is commonly referred to as 180° or 360° images, which permit the user to rotate the view about an axis. However, these types of images do not permit navigation into and through the city block or into any of the depicted places of business. Thus, the virtual city of the '661 publication does not provide the experience of actually being at the city block. Moreover, the '661 publication does not permit the user to travel from one city block to another within a navigable environment, but rather requires a selection of another city block on the interactive map which is external to the virtual environment.

In light of the foregoing, there is a need for a system and method of providing a navigable virtual subway system that provides a virtual environment in which a user can explore and learn how to use the real system, and which provides added benefits of permitting the user to obtain useful information and services while traveling within the virtual environment.

### SUMMARY OF THE INVENTION

In view of the above discussion, the shortcomings in known virtual environments is overcome, at least in part, by a navigable virtual environment that comprises, in one embodiment of the invention, a graphic representation of an environment modeled after a transportation system which is navigable by a user and which provides at least one service to the user appropriate to the transportation system. The environment is preferably rendered in three dimensions and designed to provide the user with a realistic experience in navigating the transportation system.

The environment is preferably viewed from the user's perspective in a first person view or at an angle substantially directly behind a graphic representation of the user. This will provide the user with the experience of viewing the environment as it would be viewed if the user were actually navigating within the transportation system.

In the case of a virtual subway system, the environment preferably includes a plurality of entrance and exit points demarking the points at which a user would enter and exit the system. In one example, an entrance and exit is a street level staircase that leads down into the subway system. The environment also preferably includes a rendering of a plurality of stations or platforms on which a user performs a number of possible functions, including without limitation, purchasing tickets, reviewing subway line information, and waiting for and entering a subway car. The environment continues inside the subway car and provides the user with a realistic view of the subway car and simulation of the ride to the destination station stop. In order to better prepare the user for actual travel on the subway, it is preferred that the length and time of the trip taken in the virtual subway car be substantially similar to the length and time of the actual trip. Information and tips on what subway car is preferred for entrance and egress from the car, as well as seating tips for late night travel may be provided.

In another embodiment or in combination with other embodiments described herein, textual and/or audio tips and directions are provided to the user as the user navigates the virtual environment. An interface provides the user with the ability to configure a virtual trip. Once the virtual trip is configured, the user may enter the appropriate virtual environment and commence navigation. Along the way, textual and/or audio tips and directions are provided to aid the user with navigation of the virtual environment and to enhance the user's ability to experience and learn how to make the trip. For instance, if a first person view is being utilized, graphical arrows highlighting the preferred navigation path may be presented to the user with or without audio directions to guide the user to the appropriate location in the virtual environment. Moreover, as the user passes points of interest within the environment, textual and/or audio tips may be presented to the user.

As an added feature, the navigable environment may include merchant, restaurant, or tourist locations within the subway system and a virtual environment of the surrounding neighborhood. In addition, the navigable environment may provide advertisements, coupons, or other incentives to the user that relate to such merchant, restaurant, or tourist locations.

In accordance with one embodiment of the present invention, there is provided an interactive system providing a three-dimensional view of a navigable experience to a user, comprising: a computer system capable of communicating with a user computer; a first program component operative on the computer system for generating a graphical environment displayable on the user computer, the graphical environment including a graphical three-dimensional view within a transportation system, wherein the transportation system includes a graphical three-dimensional view of a plurality of station environments and a graphical representation of at least one transportation vehicle, each station environment including at least one entrance, at least one exit, and at least one service; a second program component operative on the computer system permitting navigation of the graphical environment in response to one or more signals received from the user computer indicating a desired change in position within the graphical environment, wherein in response to the signals the computer system changes the view within the graphical environment to accommodate the indicated change in position; a third program component operative on the computer system for providing the at least one service to the user, wherein the at least one service permits the user to obtain an item for use in commerce; and wherein the graphical environment is designed to provide a substantially realistic view of an actual transportation system, and wherein the at least one transportation vehicle operates on a schedule substantially aligned with a schedule for a transportation vehicle within the actual transportation system.

In accordance with another embodiment of the present invention, there is provided a computer-readable storage medium containing a set of instructions for a general purpose computer for providing a three-dimensional view of a navigable experience to a user, the instructions comprising: a first program component operative on the computer system for generating a graphical environment displayable on the user computer, the graphical environment including a graphical three-dimensional view within a transportation system, wherein the transportation system includes a graphical three-dimensional view of a plurality of station environments and a graphical representation of at least one transportation vehicle, each station environment including at least one entrance, at least one exit, and at least one service; a second program component operative on the computer system permitting navigation of the graphical environment in response to one or more signals received from the user computer indicating a desired change in position within the graphical environment, wherein in response to the signals the computer system changes the view within the graphical environment to accommodate the indicated change in position; a third program component operative on the computer system for providing the at least one service to the user, wherein the at least one service permits the user to obtain an item for use in commerce; and wherein the graphical environment is designed to provide a substantially realistic view of an actual transportation system, and wherein the at least one transportation vehicle operates on a schedule substantially aligned with a schedule for a transportation vehicle within the actual transportation system.

In accordance with another embodiment of the present invention, there is provided A method of providing a three-dimensional view of a navigable experience to a user, the method comprising: providing resources to a user computer for generating a graphical environment displayable on the user computer and designed to provide a graphical three-dimensional view of an actual transportation system, wherein the resources cause the display and functioning of at least one transportation vehicle operating on a schedule substantially aligned with a schedule for a transportation vehicle within the actual transportation system, the graphical view of the actual transportation system including a graphical three-dimensional view of a plurality of station environments, each station environment including at least one entrance, at least one exit, and at least one service; receiving a first signal from the user computer indicating a desired change in position within the graphical environment, wherein in response to the signal the resources operate to change the view within the graphical environment to accommodate the indicated change in position; and receiving a second signal from the user computer indicative of the user interacting with at least one service to the user, wherein the at least one service permits the user to obtain an item for use in commerce.

As can be seen from the foregoing, by the present invention, a navigable environment that enables a user to travel throughout an use a transportation system is advantageously provided. Additionally, add-on features that increase the desirability, marketability, and economic benefits to the user and business owners are possible. Additional features and advantages of the system and methods of the invention are described further below.

### BRIEF DESCRIPTION OF THE FIGURES

FIG. 1 is a schematic of a system architecture in accordance with a preferred embodiment of the present invention;

FIG. 2 is an illustration of a graphical user interface for use in accordance with a preferred embodiment of the present invention;

FIG. 3 is an enlarged view of the graphical user interface of FIG. 2;

FIG. 4 is an illustration of an embodiment of the virtual environment of the present invention;

FIG. 5 is an illustration of a virtual ticket dispenser for use with the present invention; and

FIG. 6 is an illustration of an embodiment of the virtual environment of the present invention.

### DETAILED DESCRIPTION

In general, the present invention provides for a navigable virtual environment in which a transportation system is represented so as to permit users to become accustomed with use of the transportation system.

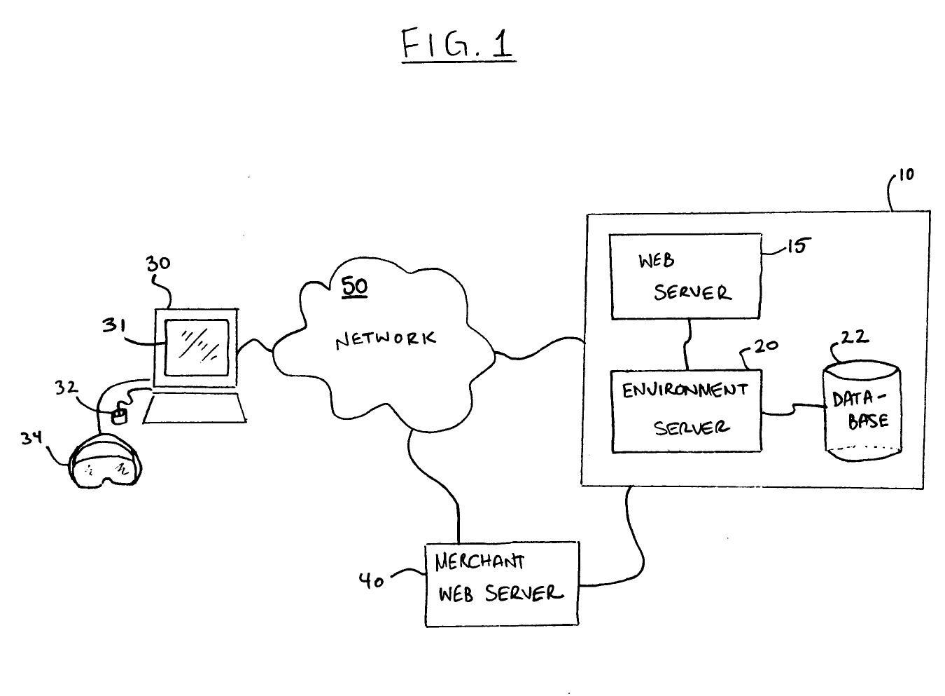

With reference now to FIG. 1, there is shown an embodiment of a system architecture for use with the present invention in which the user accesses the navigable virtual environment via a network 50, such as the Internet and/or World Wide Web. In such an embodiment, a user computer 30 is capable of communication with a system 10 for providing access to the navigable virtual environment via the network 50. The user computer 30 preferably comprises any type of personal or network computer such as an IBM-compatible computer running an Intel or AMD chipset and having an operating system, such as Microsoft Windows NT, 2000, XP, and the like, and, preferably, running a browser program such as Microsoft Internet Explorer or Netscape Navigator. Alternatively, the user computer 30 may comprise an Apple iMac, Power Mac G5, MacBook, or the like, running an Apple-based operating system, such as for example, Mac OS X. Preferably, the user computer 30 also includes software for browsing the Internet and three-dimensional environments. In one embodiment, the user computer 30 is capable of handling programming written in the Virtual Reality Modeling Language (VRML) or have a VRML-based web browser or appropriate plug-in. The user computer 30 also preferably includes a storage device such as, for example, a magnetic disk drive and magnetic disk, a CD-ROM drive and CD-ROM, DVD, or other equivalent device.

It is also within the scope of the present invention that end user computer 30 may be a handheld or table computing device, such as a personal digital assistant (PDA), pocket PC, tablet PC, cellular telephone, or the like.

Various input and output devices are also preferably provided with the user computer 30 including, by way of non-limiting example, a display 31 (e.g., cathode ray tube (CRT), liquid crystal display (LCD), etc.), and an input device 32 (e.g., a keyboard, mouse, touch pad, or light pen). In addition, virtual reality goggles 34 may be provided to enhance the sensation of navigating through the virtual environment.

Network 50 may be the Internet or the World Wide Web. In addition, network 50 may also comprise any type of wide area network (WAN) capable of servicing one or more users of the system 10. Although the connections between user computer 30, network 50, and system 10 are shown by a solid line, it will be understood that such connections are not typically direct connections, as in the manner in which an end user typically connects to an Internet site through one or more nodes, and that such connections need not be continuously available. Moreover, it will be understood that such connections need not be wired connections, and may comprise wireless connections in whole or in part.

In an embodiment, as shown in FIG. 1, system 10 provides access to the navigable virtual environment of the present invention. It will be understood that although a single user computer 30 is depicted, it is intended that system 10 be accessible to and accessed by a plurality of user computers at the same time. System 10 generally includes a web server 15 for serving the web pages that drive the user's interaction with the system 10, as described further below. In addition, the system 10 preferably comprises virtual environment server 20 and an associate database 22. Web server 15 and environment server 20 may comprise any type of known server system capable of handling the traffic and processing power necessary to serve web pages to one or more users of system 10 and to provide access to the navigable virtual environment at a sufficient level of detail and frame rates as to make the environment substantially realistic. As an example, one or more Dell PowerEdge Servers running the Intel Xeon chipset may be used. Moreover, persons of skill will recognize that multiple servers 15, 20 may be arranged in a server farm arrangement so as to handle the bandwidth and processing requirements of a particular arrangement of the present invention. Various load balancing techniques may be used to distributing traffic among the servers 15, 20 in a server farm. For example, clustering may be used to manage the server workload so that it is evenly distributed among the server nodes. A round robin technique may be used to balance the load of requests to a particular server. Database 22 may be any type of mass storage devices capable of storing large amounts of data in an organized fashion, such as known data storage devices including, but not limited to hard disks, tape drives, optical disks and the like.

In addition, as shown in FIG. 1, one or more merchant web servers 40 may be capable of communication with the user computer 30 and/or the system 10 in order to provide services to the user via the navigable virtual environment. The merchant web server 40 may be configured as detailed above with respect to the system 10.

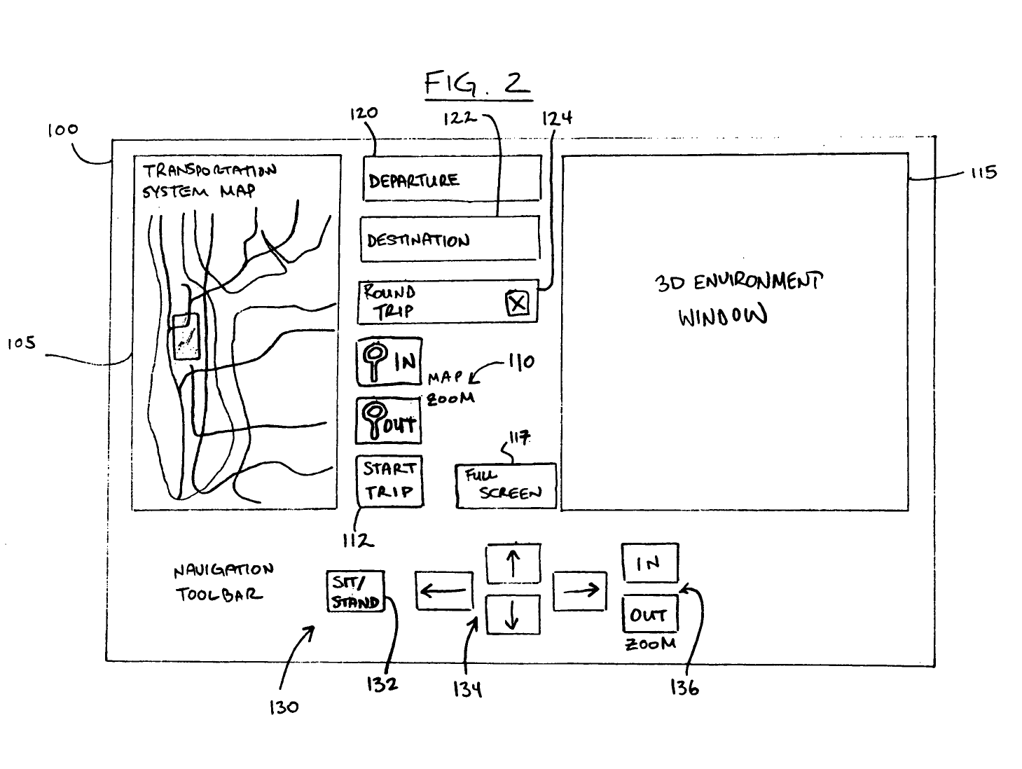

In operation, the user, using user computer 30, accesses a web site provided by the web server 15 of system 10. The web site preferably provides access to a graphical user interface (GUI) 100, as shown in FIG. 2, and a virtual environment application (not shown). Web server 15, in whole or in combination with other servers (not shown) and/or environment server 20, using resources stored in system 10, further provides the processing and resources necessary to provide the application and interactivity with GUI 100 to the user. The virtual application, GUI 100, and the associated interactivity may be realized at user computer 30 in one of a number of ways, including but not limited to a client-server or peer-to-peer arrangement. It is preferred, however, that the virtual application, GUI 100, and the associated interactivity is configured in a client-server architecture with system 10 handling requests through GUI 100 and one or more sub-GUIs and providing appropriate interactivity and resources. In an alternate embodiment, the virtual application and associated resources may be provided to the user as a fully contained application on a storage medium, such as a CD-ROM or DVD-ROM disc. Moreover, the virtual application and associated resources may be download, in whole or in part, via network 50.

The virtual environment application includes resources that enable the display and navigation of a virtual environment that is intended to replicate a real environment, such as a known transportation system. Persons of ordinary skill in the art will recognize that it is within the scope of the present invention that the transportation system include many types of transportation systems including, but not limited to, subways or other rail transportation systems, bus systems, naval or air travel systems, passenger automobile transportation systems, or any combination thereof. The virtual environment preferably includes a substantially realistic 3D view of the actual environment that it is supposed to replicate, including the length of platforms, height of walls and ceilings, artwork, tiling, and other features that would convey familiarity with a station to the user. Moreover, in the case of a virtual subway system, the tunnels are preferably modeled and interconnected in the same fashion as the real subway system to enable the user to take a virtual train from the departure point to a destination. The modeling of the virtual environment is performed in the manner now known in the art or hereafter developed, such as by filming or photographing the actual environment from multiple views and then graphically modeling the space in three-dimensions in a computer.

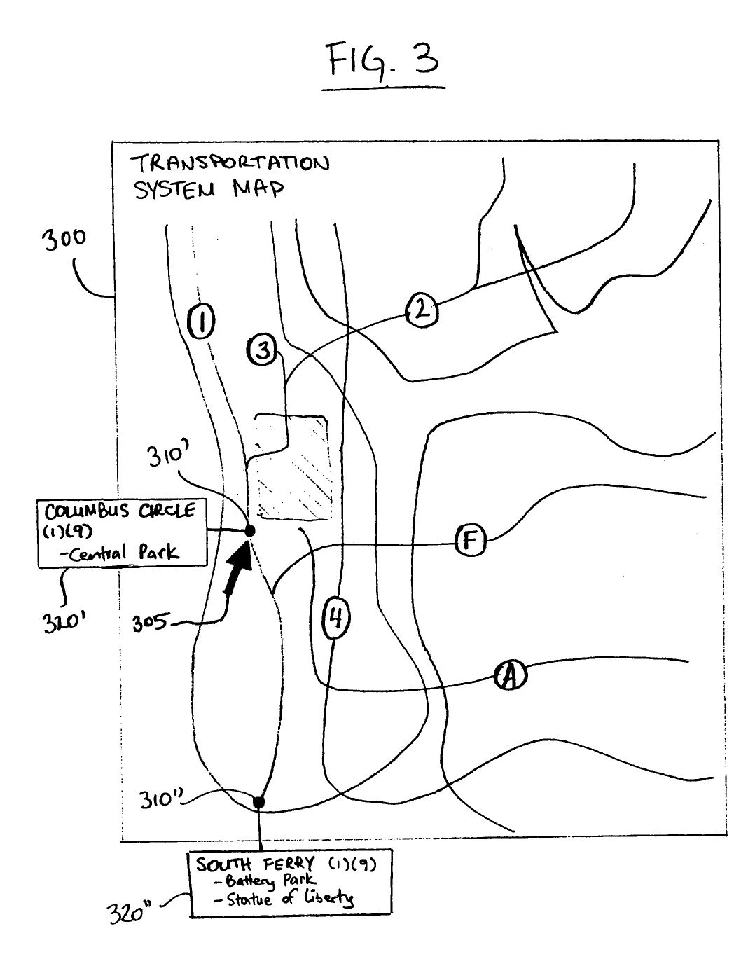

In a preferred embodiment, as shown in FIG. 2, GUI 100 preferably includes a multi-zoned interface that includes, but is not limited to, the following elements: a map display 105, map zoom buttons 110, 3D environment window 115, screen toggle button 117, departure and destination drop down menus 120, 122, trip selector button 124, and the navigation toolbar 130. The navigation toolbar 130 preferably includes, but is not limited to, a sit/stand toggle button 132, directional keys, 134, and zoom buttons 136. In a preferred embodiment of GUI 100, map display 105 is interactive is will allow a user to view a two-dimensional view of the transportation system map (e.g., a map of the NYC subway system). The map display 105 preferably displays at least a portion of the stops in the transportation system. The map display 105 also preferably displays various places of interest and may include a call-out box explaining the places of interest at each stop, as shown in FIG. 3 and described further below. By using map zoom buttons 110, the user can zoom in and out of the map to look more closely at a particular stop or places of interest near the desired stops. The map display 105 is preferably, but not necessarily, configured to have a rich base of information concerning places of interest so as to aid the user in selecting stops.

In one embodiment, selection of a departure or destination on map display 105 is accomplished by having the user “click” or “tap” on stops in the map display 105 with a mouse or other pointing device. This selection preferably automatically fills the departure and destination drop down menus 120, 122 with the user selections. In such an embodiment, the first selection would be for the departure point and the second selection would be for the destination point. The departure and destination stops may also be manually selected by the user using the departure and destination drop down menus 120, 122.

The trip selector button 124 permits the user to indicate whether the trip is a one-way or round trip. By indicating that the trip is a round trip, the system 10 will permit the user to experience entering and exiting the transportation system and then re-entering and exiting. This feature may be used to allow the user to experience entering and exiting the transportation system at the same stop from different entrances/exits. For example, at some subway stops the entrance to the uptown side is different from the entrance to the downtown side. By enabling a user to indicate that the trip is a round trip, the user can experience the subway stop from both directions and, perhaps, avoid errors when the trip is actually made.

Once the trip is configured, the user can select the start trip button 112. The start trip button 112 is configured to launch the trip simulation in the 3D environment window 115 of the GUI 100. Via a full screen button 117, the user can toggle the display of the 3D environment window 115 between the view shown in FIG. 2 and a full screen view (not shown).

With reference to FIG. 3, there is shown an enlarged view of the system map 300 (shown as 105 in FIG. 1). As shown, the map 300 may be interactive and permit the user to hover the pointer 305 over an indicated station stop 310′, 310″ to display information boxes 320′, 320″. Information boxes 320′, 320″ preferably contain information concerning the station stop, the train line, and one or more notable sites in the area of the station stop. It will be understood that map 300 may be configured to contain additional interactive features that provide notable information to users.

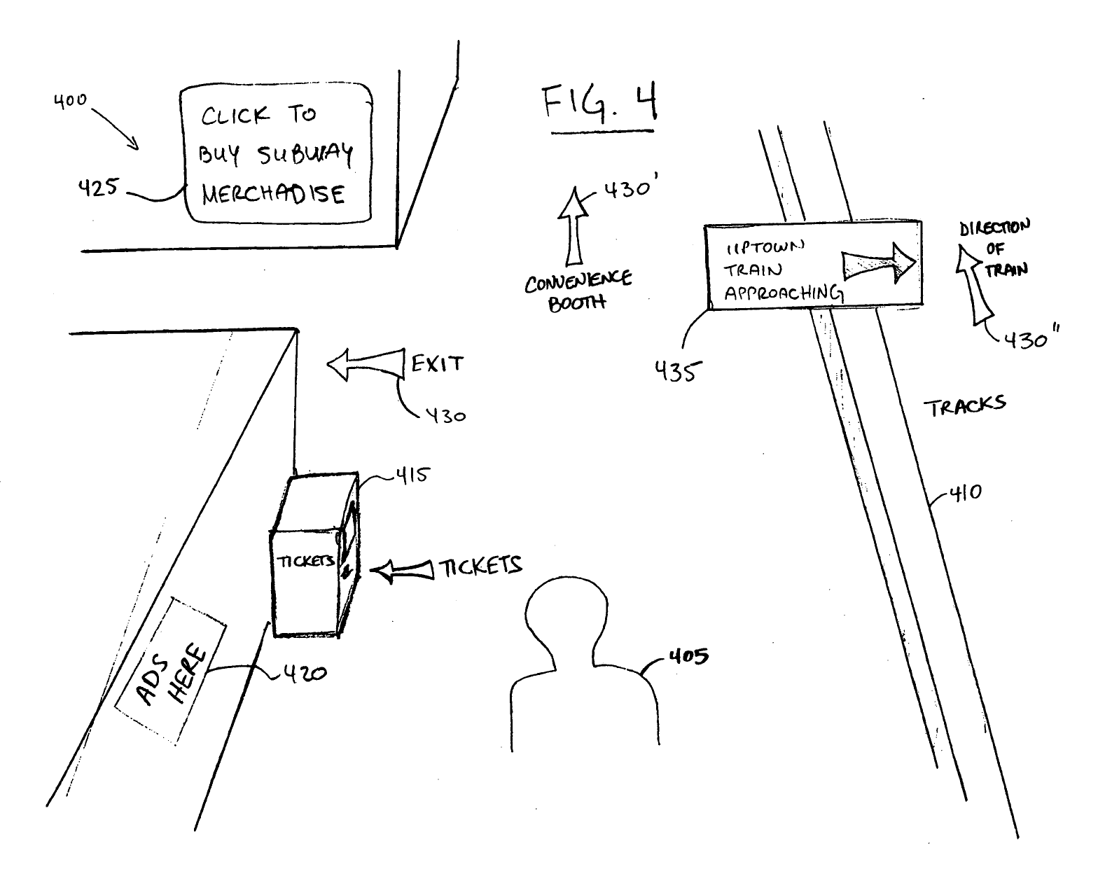

With reference now to FIGS. 4-6, the virtual environment is preferably a three-dimensional virtual environment 400 which a user can navigate by walking or running by using the directional keys 134 of navigation toolbar 130, as shown in FIG. 2, or by using a joystick, mouse, pointer or other device for indicating the direction of navigation. The point-of-view preferably is a first person point of view or a third person point-of-view from behind a 3D graphical representation of a human 405, as shown in FIG. 4. In a preferred embodiment of the present invention, the user would be provided with a selection of graphical characters to select from or may be provided with functionality to enable the user to configure or create their character as is known in various video games.

In the example of FIG. 4, the environment 400 is the subway train platform 410. The train platform 410, in a preferred embodiment, is a graphical replica of an actual train platform within the subject transportation system. The train platform 410, therefore, preferably includes the layout, stairways, halls, exits, ramps, and items normally found in the subject train station that the train platform 410 is intended to replicate. For example, as shown in FIG. 4, an automated ticket dispenser 415 is shown. The automated ticket dispenser 415 replicates an actual dispenser located in approximately that same location within the real train station. By placing such objects in their realistic locations, the environment 400 replicates the real station and enables a user to navigate throughout the station so that the user can be better prepared to travel the route at a later time.

In a preferred embodiment, the automated ticket dispenser 415 is operational and the user can navigate over to the ticket dispenser 415 and purchase tickets. In the NYC subway system, for instance, the virtual ticket dispenser is known as a Metro Card Vending Machine (MVM). In the case of the NYC subway system, as opposed to the NJ Transit train system for example, fares must be purchased prior to gaining access to the platform. Although this scenario is not shown in the FIGS., it will be understood to be within the scope of the present invention to provide for the purchase of fares (e.g., MTA Metro Cards) prior to passing through a turnstile or other barrier and gaining access to the train platform.

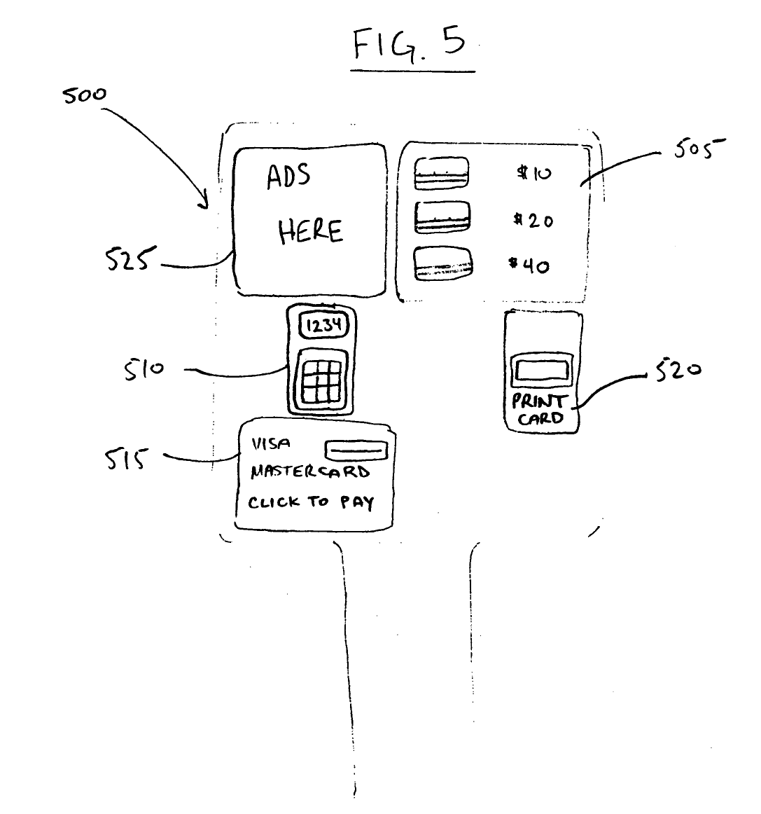

As shown in FIG. 5, a virtual representation of ticket dispenser 500 is shown. The user may use the mouse or other pointing device to interact with the ticket dispenser 500. The virtual ticket dispenser 500 may include a display 505 for displaying the products available to the user for purchase. In addition, the virtual ticket dispenser 500 may include a keypad 510 for entering numerical information relevant to the purchase. The virtual ticket dispenser 500 may further include an option for paying by credit/debit card by including a payment button 515 to allow the user to pay by credit/debit card. Once the transaction is complete, a print card button 520 may be included to trigger printing of the card for use in the transportation system. Furthermore, in a preferred embodiment, the virtual ticket dispenser 500 includes a display 525 for displaying advertisements and the like. In a preferred embodiment, for transportation systems that utilize specific types of virtual ticket dispensers, a tutorial can be provided to aid the user in learning how to use the system. The option to purchase tickets or fares from a graphical representation of a ticket agent may also be provided.

Persons of skill in the art will also recognize that the virtual environment may be configured to include objects and items that are not in the actual transportation system. For example, as shown in FIG. 4, billboard advertisements 420 that are not in the actual station or are in lieu of actual billboard advertisements may be included to generate revenue through the virtual environment 400. These billboards 420 may be static, animated, or interactive. For example, a local restaurant at the station being represented by environment 400 may wish to advertise and offer coupons for dining or display its menu. As such, the billboard 420 can be made interactive so as to permit the functionality for the user to obtain coupons, gift cards, menus, and other such products. As an added feature, the environment 400 may include billboards 425 that enable the user to shop for merchandise at one or more online merchant sites. Thus, by selecting billboard 425, the user can enter an online store (whether by updating window environment 115 or launching a new window). In addition, in order to support local communities and associated organizations, community based organizations may be permitted to promote their events or services to visitors at the particular subway station at which they are located.

Advertisements may also be targeted based upon a user profile or past use of the virtual environment application. For example, historical data on previous trips or other interactions within the virtual environment by a particular user may be stored in database 22 (shown in FIG. 1) or a related database system capable of communication with system 10, based on these past interactions and travels, environment system 20 can target advertisements to the user. For example, if the user on one or more occasions took the train to Chinatown in NYC and viewed menus for various Chinatown restaurants, promotions or coupons from Chinatown restaurants could be targeted to the user, even if the user is not currently using the virtual environment application to plan a trip to Chinatown. In this way, merchants could extend their reach beyond their geographical location within the virtual environment application. As a further example, if the user repeatedly uses the virtual No. 4 train to travel to Yankee Stadium, then the virtual environment application could be programmed to target Major League Baseball or New York Yankees related merchandise to the user.

Further, the virtual environment application can be used to educate potential riders to become aware of suspicious behavior and where and how to report it. In addition, information and tips may be provided to users as to the dangers of travel at certain times of the day. The information may include: where to enter and exit the station, what stations to avoid or use, where to stand on the train or platform, and where police and attendants are located within the station. The virtual environment application could also be used by police departments to reenact a crime committed within the transportation system. Information concerning lost and found locations may also be provided.

With reference again to FIG. 4, environment 400 may also include directional pointers 430, 430′, and 430″. These directions pointers are preferably configured to aid the user (especially the first time user) with navigation of the subway station. For example, directional pointer 430 points the user towards the exit, while direction pointer 430′ point the user towards a convenience booth, such as a newspaper stand, in the station. Directional pointer 430″ indicates the direction that the train will be traveling. Environment 400 may also include information popup 435 that displays important or notable information to the user to aid in the user's navigation and use of environment 400.

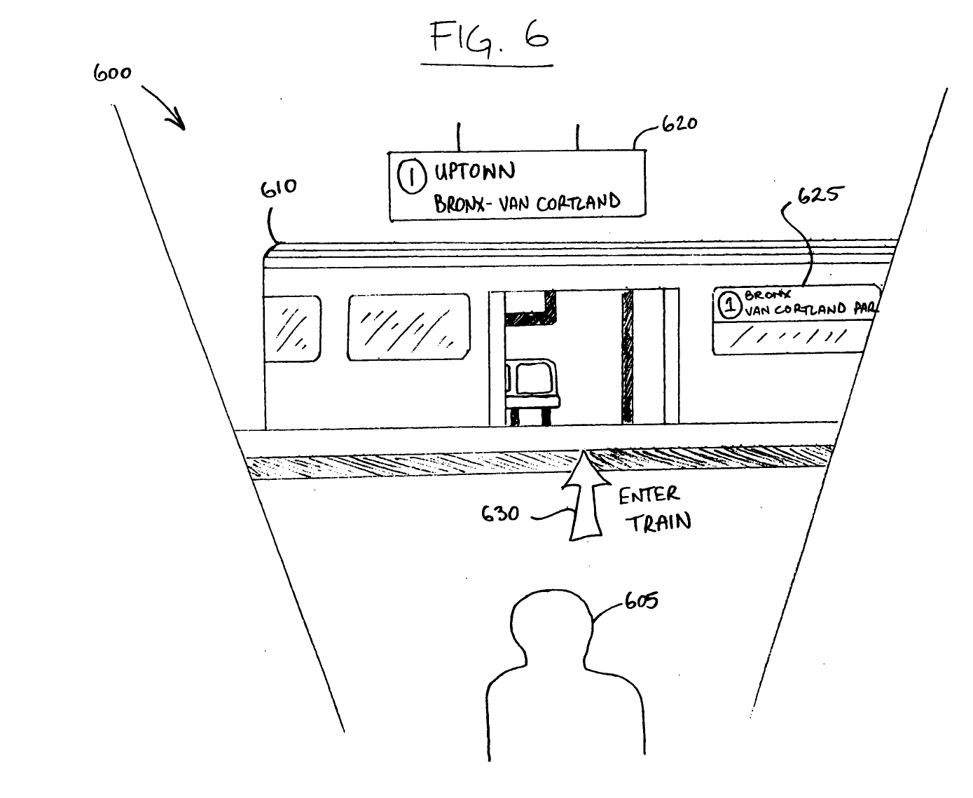

With reference now to FIG. 6, there is shown a view of the virtual environment 600 in which a train is arriving in the station. The graphical representation 605 of the user (again shown in the third person) is facing the open doors of the virtual train 610. The environment 600 depicts various informational cues as would be found at the actual train station, such as by way of non-limiting example, information placard 620 and train sign 625. A directional indicator 630 may also be provided to guide the user. In a preferred embodiment, the virtual environment 600 will be extended into the virtual train 610 itself, such that the user 605 can enter the virtual train 610 and sit down. In this way, the user 605 can actually ride the train 610 to his/her destination and experience the trip as he/she would in real-life. Advertisements (not shown) may also be displayed on the sides of trains or within the environment of the virtual train 610.

It is preferred that the trains arrive and depart from the stations at approximately the times they would arrive and depart at the actual station. This may enable the user to better coordinate his/her travel plans. However, functionality may also be provided to allow the user to slow down the arrival and departure of trains for training purposes. Moreover, in order to aid the user with entrance of the train 610, the length of time that the train 610 remains stopped may be lengthened beyond what is the normal stop time or the stop may be configured to be realistic to train the user to be prepared for approaching trains. Local and express trains would preferably arrive and depart from the station as in actuality so as to train the user as to what trains he/she should take or avoid depending on the destination.

In a freestyle mode of the present invention, the user can enter the system at a departure site and roam freely within the subway system getting on and off trains at various stops as the user sees fit. This will help aid familiarity with the transportation system without the user ever having actually used the system.

As an additional feature of the virtual environment application, the system 10 may be provided as an online multi-user environment. In this way, multiple users can simultaneously use the virtual environment application thereby creating a community of users. This would provide the realism of using the actual transportation with other riders. Moreover, various community based features would be built into the virtual environment application. For example, each station or train within the virtual environment could have a bulletin board where one user could post a note to other users. Postings could be made for community events, job openings, lost/found items, odd job services, and apartment rentals/sub-leases, to name a few. Further, users could interact with the other users through a chat or instant messaging. In this way, the user could make new acquaintances online or meet a person they may have seen riding the actual train and wished to make their acquaintance, but missed the opportunity.

In accordance with another embodiment of the present invention, there is provided a method of providing a three-dimensional view of a navigable experience to a user. The method comprises providing resources to a user computer for generating a graphical environment displayable on the user computer; receiving a first signal from the user computer indicating a desired change in position within the graphical environment; and receiving a second signal from the user computer indicative of the user interacting with at least one service to the user. Persons of ordinary skill in the art will recognize that it is within the scope of the present invention that the resources may be provided on a disk based storage medium, a flash drive or at least in part via a network connection.

Thus, while there have been shown and described fundamental novel features of the invention as applied to the exemplary embodiments thereof, it will be understood that omissions and substitutions and changes in the form and details of the disclosed invention may be made by those skilled in the art without departing from the spirit of the invention. It is the intention, therefore, to be limited only as indicated by the scope of the claims appended hereto.

I claim:

1. An interactive system providing a three-dimensional view of a navigable experience to a user, comprising:
a computer system capable of communicating with a user computer;
a first program component operative on the computer system for generating a graphical environment displayable on the user computer, the graphical environment including a graphical three-dimensional view within a transportation system, wherein the transportation system includes a graphical three-dimensional view of a plurality of station environments and a graphical representation of at least one transportation vehicle, each station environment including at least one entrance, at least one exit, and at least one service;
a second program component operative on the computer system permitting navigation of the graphical environment in response to one or more signals received from the user computer indicating a desired change in position within the graphical environment, wherein in response to the signals the computer system changes the view within the graphical environment to accommodate the indicated change in position;
a third program component operative on the computer system for providing the at least one service to the user, wherein the at least one service permits the user to obtain an item for use in commerce; and
wherein the graphical environment is designed to provide a substantially realistic view of an actual transportation system, and wherein the at least one transportation vehicle operates on a schedule substantially aligned with a schedule for a transportation vehicle within the actual transportation system.

2. The interactive system of claim 1, wherein the environment is viewed from the user's perspective in a first person view or at an angle substantially directly behind the graphical representation of the individual.

3. The interactive system of claim 1, wherein the service is selected from the group consisting of purchasing tickets to the transportation system, shopping, collecting discount coupons and making hotel and restaurant reservations.

4. The interactive system of claim 1, wherein the environment includes advertisements, coupons, or other incentives to the user that relate to merchants, restaurants or tourist locations.

5. The interactive system of claim 1, wherein the transportation system is a subway system.

6. The interactive system of claim 5, wherein the graphical representation of the at least one transportation vehicle is a subway car.

7. The interactive system of claim 6, wherein the second program component permits navigation of the graphical environment substantially in real time, whereby the subway car enters and exits the station at approximately the times it would arrive and depart at the actual station.

8. The interactive system of claim 1, wherein the transportation system is a rail transportation system.

9. The interactive system of claim 1, wherein the transportation system is a bus system.

10. The interactive system of claim 1, wherein the transportation system is a naval travel system.

11. The interactive system of claim 1, wherein the transportation system is a air travel system.

12. The interactive system of claim 1, wherein the transportation system is a passenger automobile transportation system.

13. The interactive system of claim 1, wherein the transportation system is a combination of a subway system and a bus system.

14. A computer-readable storage medium containing a set of instructions for a general purpose computer for providing a three-dimensional view of a navigable experience to a user, the instructions comprising:
a first program component operative on the computer system for generating a graphical environment displayable on the user computer, the graphical environment including a graphical three-dimensional view within a transportation system, wherein the transportation system includes a graphical three-dimensional view of a plurality of station environments and a graphical representation of at least one transportation vehicle, each station environment including at least one entrance, at least one exit, and at least one service;
a second program component operative on the computer system permitting navigation of the graphical environment in response to one or more signals received from the user computer indicating a desired change in position within the graphical environment, wherein in response to the signals the computer system changes the view within the graphical environment to accommodate the indicated change in position;
a third program component operative on the computer system for providing the at least one service to the user, wherein the at least one service permits the user to obtain an item for use in commerce; and
wherein the graphical environment is designed to provide a substantially realistic view of an actual transportation system, and wherein the at least one transportation vehicle operates on a schedule substantially aligned with a schedule for a transportation vehicle within the actual transportation system.

15. A method of providing a three-dimensional view of a navigable experience to a user, the method comprising:
providing resources to a user computer for generating a graphical environment displayable on the user computer and designed to provide a graphical three-dimensional view of an actual transportation system, wherein the resources cause the display and functioning of at least one transportation vehicle operating on a schedule substantially aligned with a schedule for a transportation vehicle within the actual transportation system, the graphical view of the actual transportation system including a graphical three-dimensional view of a plurality of station environments, each station environment including at least one entrance, at least one exit, and at least one service;
receiving a first signal from the user computer indicating a desired change in position within the graphical environment, wherein in response to the signal the resources operate to change the view within the graphical environment to accommodate the indicated change in position; and
receiving a second signal from the user computer indicative of the user interacting with at least one service to the user, wherein the at least one service permits the user to obtain an item for use in commerce.

16. The method of claim 15, wherein the resources are provided at least in part on a disk based storage medium.

17. The method of claim 15, wherein the resources are provided at least in part on a flash drive.

18. The method of claim 15, wherein the resources are provided at least in part via a network connection.

19. The method of claim 15, wherein the environment is viewed from the user's perspective in a first person view or at an angle substantially directly behind the graphical representation of the individual.

20. The method of claim 15, wherein the service is selected from the group consisting of purchasing tickets to the transportation system, shopping, collecting discount coupons and making hotel and restaurant reservations.

21. The method of claim 15, wherein the environment includes advertisements, coupons, or other incentives to the user that relate to merchants, restaurants or tourist locations.

22. The method of claim 15, wherein the transportation system is a subway system.

23. The method of claim 15, wherein the transportation system is a rail transportation system.

24. The method of claim 15, wherein the transportation system is a bus system.

25. The method of claim 15, wherein the transportation system is a naval travel system.

26. The method of claim 15, wherein the transportation system is a air travel system.

27. The method of claim 15, wherein the transportation system is a passenger automobile transportation system.

28. The method of claim 15, wherein the transportation system is a combination of a subway system and a bus system.
